(19) United States
(12) Patent Application Publication
(10) Pub. No.: US 2015/0007748 A1
(43) Pub. Date: Jan. 8, 2015

(54) CRT WASTE TREATMENT AND RECYCLING

(71) Applicant: Peoria Disposal Company, Peoria, IL (US)

(72) Inventor: Ronald J. Welk, Peoria, IL (US)

(21) Appl. No.: 14/309,946

(22) Filed: Jun. 20, 2014

Related U.S. Application Data
(60) Provisional application No. 61/843,097, filed on Jul. 5, 2013.

(51) Int. Cl. A62D 3/36

(52) U.S. Cl. CPC A62D 3/36
USPC 106/286.6; 422/119

(57) ABSTRACT

A method comprises: reducing cathode ray tube (CRT) glass waste to a piece size of less than or equal to 2 inches (nominal) in any dimension; mixing a chemical treatment agent comprising a blend of dolomitic lime and fly ash with the CRT glass waste; mixing the mix of the chemical treatment agent and the CRT glass waste with a mixing liquid to form a pre-cured blend; and curing the pre-cured blend to form a treated CRT glass waste. In one implementation, treated CRT glass waste has characteristics facilitating its use as a daily cover material in a landfill.

### CROSS-REFERENCE TO RELATED PATENT APPLICATIONS

The present application is a non-provisional application claiming priority from co-pending U.S. Provisional Application Ser. No. 61/843,097 filed on Jul. 5, 2013 by Ronald J. Welk and entitled CRT WASTE TREATMENT AND RECYCLING, the full disclosure of which is hereby incorporated by reference.

### BACKGROUND

Technological advances have made obsolete the use of cathode ray tubes in computer monitors and televisions. As a result, previously used cathode ray tubes are currently being stockpiled. Disposal and/or recycling of such cathode ray tubes is difficult as many states restrict or prohibit the disposal of electronic waste in landfills, and such cathode ray tubes may include heavy metals regulated as hazardous waste.

### BRIEF DESCRIPTION OF THE DRAWINGS

FIG. 1 is a schematic illustration of an example cathode ray tube treatment and recycling system.

FIG. 2 is a perspective view of a stockpile of discarded cathode ray tubes.

FIG. 3 is a flow diagram of an example method of treating cathode ray tube glass waste that may be carried out by the system of FIG. 1.

FIG. 4 is a sectional view of an active landfill including a daily cover formed from recycled treated cathode ray tube glass.

FIG. 5 is a sectional view of the daily cover of FIG. 4.

### DETAILED DESCRIPTION OF THE EXAMPLE EMBODIMENTS

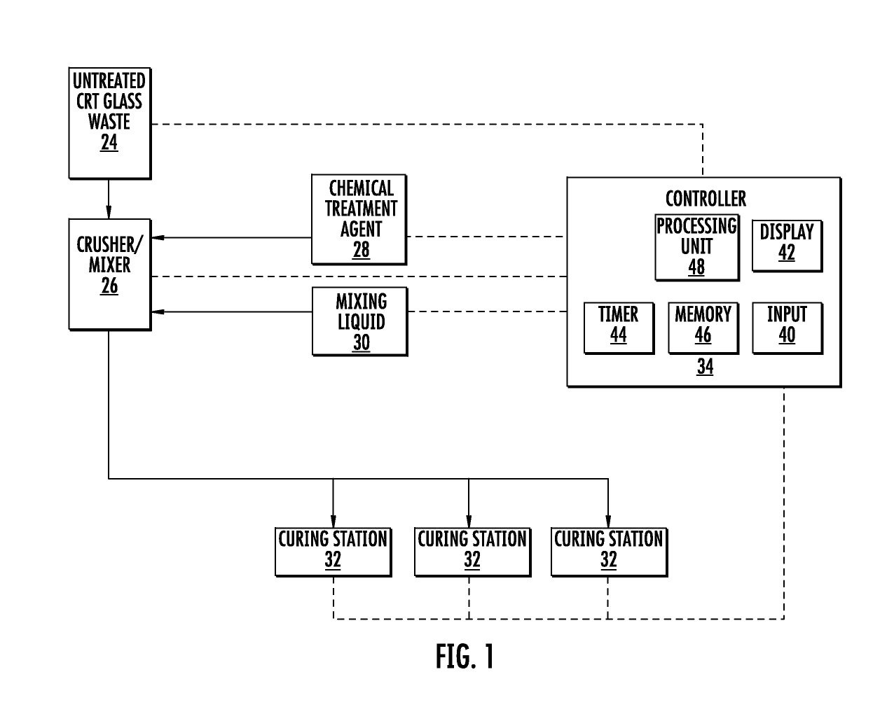

FIG. 1 schematically illustrates an example cathode ray tube treatment and recycling system 20. System 20 facilitates the treatment and recycling of cathode ray tubes. System 20 comprises untreated cathode ray tube source 24, mixer 26, chemical treatment agent source 28, mixing liquid source 30, curing stations 32 and controller 34. Cathode ray tube source 24 comprises a hopper, bin, bay or other storage method for containing untreated cathode ray tubes such as untreated cathode ray tube (CRT) glass waste. In one implementation, source 24 further comprises one or more mechanisms for selectively delivering such cathode ray tube glass waste to mixer 26 in response to signals from controller 34.

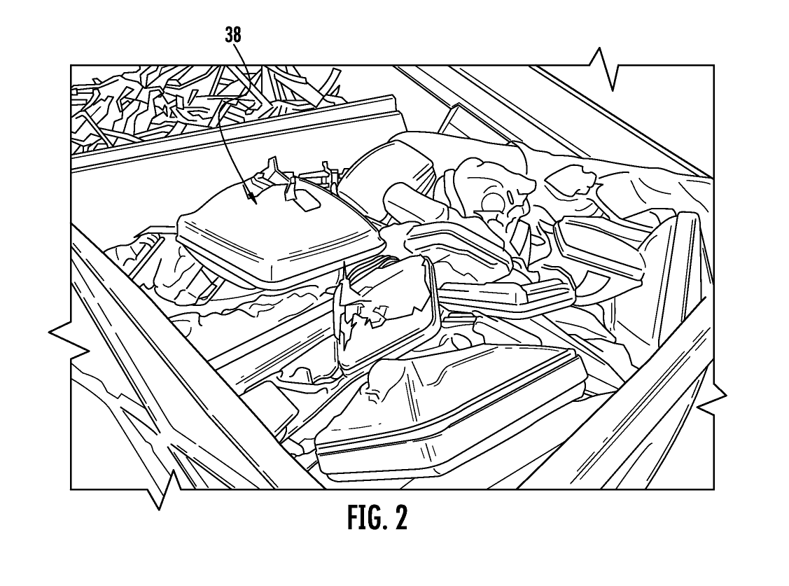

FIG. 2 illustrates an example stockpile 37 of cathode ray tubes 38. As the use of cathode ray tubes has become obsolete due to technological advances, previously used and discarded cathode ray tubes have been stockpiled in warehouses awaiting proper disposal. In one implementation, cathode ray tube source 24 may contain such cathode ray tubes or entire glass components of such components. In one implementation, cathode ray tube source 24 may contain cathode ray tube glass waste that has already been reduced in size to a piece size of less than or equal to 6 inches in any dimension. Such untreated cathode ray tube glass waste contained in source 24 may contain heavy metals regulated as hazardous waste.

Mixer 26 comprises one or more devices by which the CRT glass waste, chemical treatment agent, and mixing liquid are thoroughly blended to accomplish the waste treatment purpose. The internal components of mixer 26 are so configured that some size reduction of the cathode ray tube glass waste occurs, reducing the CRT glass waste to a piece size of less than or equal to 2 inches (nominal) in any dimension, rendering the CRT glass waste more amenable to treatment. In one implementation, mixer 26 may comprise a single rotary mixer which through rotation causes the CRT glass waste to be thoroughly blended with the chemical treatment agent and mixing liquid. In one implementation, the CRT glass waste is reduced in size as the waste is lifted and falls within the mixer and collides with sides of the mixer as well as other CRT glass waste pieces, or is crushed against the walls of the mixer by the internal mixer 26 components. In other implementations, mixer 26 may comprise distinct components or machines where in one component or machine reduces the size of the CRT glass waste while a second component or machine receives and mixes the CRT glass waste with the chemical treatment agent and mixing liquid. Other examples of crushers which may be used to reduce the size of the CRT glass waste include, but are not limited to, jaw crushers, gyratory crushers, cone crushers, compound crushers, horizontal shaft impactors, vertical shaft impactors and mineral sizers.

Chemical treatment agent source 28 comprises one or more hoppers, bins or other storage devices to contain a chemical treatment agent and to selectively deliver or supply the chemical treatment agent to the mixer 26 (the mixing component of the mixer 26) under the control of controller 34. The chemical treatment agent supplied by source 28 is a chemical agent, which may be a single chemical or a blend of more than one chemicals, that reacts with the heavy metals and other elements of the CRT glass waste to treat the waste such that the waste is chemically safe or sufficiently inert as to render it a non-hazardous waste suitable for disposal in a landfill as defined by the Resource Conservation and Recovery Act (RCRA) and 40 Code of Federal Regulations Parts 261 and 268, as evidenced by satisfying United States Environmental Protection Agency (USEPA) treatment standards, sometimes expressed in Toxicity Characteristic Leaching Procedure (TCLP) concentrations. In one implementation, the chemical treatment agent is further configured to physically interact with the CRT waste so as to form an aggregate that has reduced permeability. In particular, in one implementation, the chemical treatment agent is configured to sufficiently fill voids between pieces of the CRT glass waste such that the formed aggregate may be recycled and used as daily cover in a landfill.

In one implementation, chemical treatment agent source 28 contains and supplies a chemical treatment agent largely comprising dolomitic lime and fly ash. In one implementation, the chemical treatment agent supplied by source 28 comprises a substantially equal blend of dolomitic lime and fly ash. For purposes of this disclosure, a blend is “substantially equal” when the percentages of dolomitic lime and fly ash are within 30% by weight or volume of one another. In one implementation, the chemical treatment agent comprises an approximate 50:50 blend by weight or volume of dolomitic lime and fly ash. In one implementation, the fly ash itself is recycled, originating as a byproduct of coal combustion.

Mixing liquid source 30 comprises a source of liquid for being mixed with the untreated CRT glass waste and the chemical treatment agent within the mixing component of mixer 26. Mixing liquid source 30 is configured to properly apply an amount of such mixing liquid to facilitate rapid and thorough mixing or blending of the chemical treatment agent and CRT glass waste, as well as initiate the chemical reaction that accomplishes the primary purpose of waste treatment. In one implementation, mixing liquid source 30 supplies water under the control of controller 34. In another implementation, mixing liquid source 30 may supply other forms of liquid that facilitate mixing and blending and that may perform other functions. In some implementations, mixing liquid source 30 may be omitted.

Curing stations 32 comprise chambers, containers or other storage vessels to contain the blend or mixture of CRT glass waste, chemical treatment agent and mixing liquid during the curing process (the time during which the chemical reaction progresses sufficiently to accomplish the purpose of the waste treatment). In the example illustrated, system 20 comprises a plurality of such curing stations 32 (three of which are shown), allowing mixer 26 and the remainder of system 20 to be more fully utilized while awaiting curing of the CRT glass waste. In other implementations, system 20 may include greater or fewer of such curing stations 32. In some implementations, curing stations 32 may be omitted where the blend or mixture of CRT glass waste, chemical treatment agent and mixing liquid is permitted to reside in the mixer 26 while it cures. In such an implementation, mixer 26 serves as a curing station or curing volume. In some implementations, no minimum curing time is required to accomplish the purpose of the waste treatment.

Controller 34 comprises an electronic device that controls the operation of system 20. Controller 34 may comprise input 40, display 42, timer 44, memory 46 and processing unit 48. Input 40 comprises one or more devices by which commands, instructions, settings and/or data may be entered to system 20. For example, input 40 may facilitate the entry of data regarding characteristics of the CRT glass waste being supplied by source 24 such as the particular chemical treatment agent proportions, the particular heavy metals that may exist within such waste, the current size of the pieces of the CRT glass waste, the volume or weight of the CRT glass waste to be treated, the permitted time for completing such treatment and the like. Input 40 may facilitate the input of data regarding the particular chemical treatment agent being supplied by source 28. For example, input 40 may facilitate the input of the composition of the chemical treatment agent including its ingredients, proportions or mass. Input 40 may further facilitate the input of desired final product treatment standards or results which may impact how CRT glass waste is processed by system 20. Tougher treatment standards may be entered through input 40, wherein controller 34 may adjust the operational settings of system 20 to satisfy such requested standards. Input 40 may comprise a keyboard, keypad, switches, microphone with speech recognition software, a mouse, a touch screen or other input devices. In some implementations, input 40 may comprise a plug, port or antenna for receiving wired or wireless information, settings, data, controls or the like through a local area network or wide area network (Internet). In some implementations, input 40 may be omitted.

Display 42 comprises a monitor, screen or series of light emitting diodes or the like by which settings or other data may be visually communicated to an operator. In one implementation, display 42 may comprise a touch screen, wherein display 42 also serves as part of input 40. Controller 34 and system 20 may utilize display 42 to present information to an operator such as the instant weight of the ingredients in mixer 26, stage or state of treatment for an ongoing batch of CRT glass waste, the expected or desired characteristics of the final treated CRT glass waste, the time at which such treatment will have been completed, the time at which such treatment began, the composition of the CRT glass waste, the composition of the chemical treatment agent, the amount or composition of the mixing liquid, the current piece size of the CRT glass waste and the like.

Timer 44 comprises one or more digital or analog device for tracking time of various operations of system 20. Timer 44 may be utilized to track lapse of time during which untreated CRT glass waste is being reduced in size to achieve a desired size or dimension. Timer 44 may be utilized to track the lapse of time during mixing of the CRT glass waste, the chemical treatment agent and the mixing liquid to achieve predetermined or selected degree of mixing of the ingredients. Timer 44 may further be utilized to track lapse of time while the pre-cured blend or mixture of CRT glass waste, chemical treatment agent and mixing liquid 30 is being cured in each curing station 32 (or in mixer 26) to ensure sufficient curing and treatment. In some implementations, timer 44 may be omitted.

Memory 46 comprises a non-transient or non-transitory computer-readable medium for storing computer-readable programming or code for providing instructions directing the operation of processor 48 in the generation of control signals to direct the operation of system 20. In some implementations, memory 46 further contains and stores operational settings for system 20 as well as input or entered data or settings received via input 40. Memory 46 may be embodied as a persistent storage device such as a read-only memory, a random access memory, a flash memory, a disk or the like.

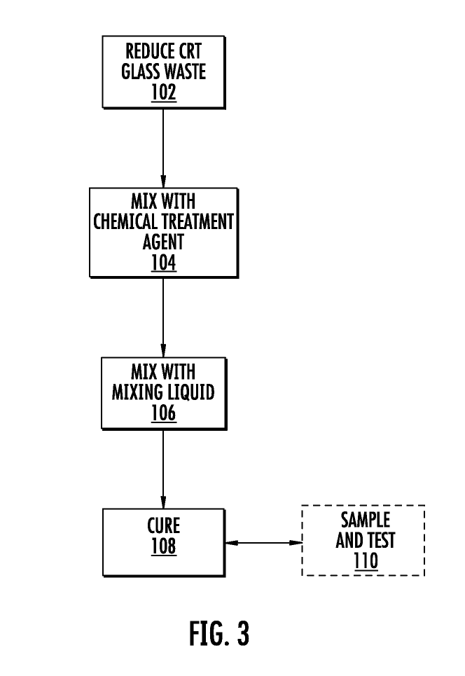

Processing unit 48 comprises one or more processing units configured to carry out analysis and generate control signals under the instruction of code contained in memory 46. In some implementations, at least portions of such operational instructions contained in memory 46 and carried out by processing unit 48 may alternatively be embodied as part of an application-specific integrated circuit (ASIC). Processing unit 48 carries out instructions provided by memory 46 to carry out the treatment method 100 outlined in FIG. 3.

FIG. 3 is a flow diagram illustrating an example method for treating CRT glass waste that may be carried out by system 20 or that may be carried out by other systems. As indicated by step 102, the size of the CRT glass waste may be reduced, depending on its size when placed into mixer 26. In one implementation, with respect to system 20 described in FIG. 1, controller 34 generates control signals directing source 24 to deposit the untreated CRT glass waste into/mixer 26. In other implementations, the untreated CRT glass waste is deposited into mixer 26 by portable heavy equipment. Depending upon the initial size of the untreated CRT glass waste, as may be entered through input 40 or as sensor detected by one or more sensors, controller 34 directs the operation of mixer 26 to reduce the size of the CRT glass waste to a piece size of no greater than 2 inches (nominal) in any dimension. In one implementation, depending upon the initial size of the CRT glass waste, controller 34 may generate control signals adjusting the operational speed and direction of mixer 26 as well as adjusting the operational time (using timer 44) to achieve the piece size of no greater than 2 inches (nominal). Because system 20 reduces the size of the pieces of CRT glass waste to no greater than 2 inches (nominal) in any dimension, the CRT glass waste is more amenable to treatment using the chemical treatment agent from source 28. Moreover, the reduced size of the CRT glass waste results in a formed final aggregate having relatively little void space, a sufficient density and grain size such that the aggregate more adequately retains the chemical treatment agent 28 within its voids and is satisfactory for use as daily cover in a landfill, limiting or reducing the need to use soil or other daily cover materials. In one implementation, the desired reduction in size of the CRT glass waste is achieved using program settings (crushing and mixing settings and times). In another implementation, the desired reduction in size of the CRT glass waste is achieved through manual operation based upon visual inspection of the CRT glass waste as it is being reduced in size.

As indicated by step 104, controller 34 further generates control signals causing source 28 to supply the chemical treatment agent to the mixer 26. In the example illustrated, source 28 supplies a chemical treatment agent to the CRT glass waste within the mixer 26 after the CRT glass waste has been reduced in size. In another implementation, controller 34 may generate control signals causing source 28 to supply the chemical treatment agent to the CRT glass waste within mixer 26 before or while it is being reduced in size. Concurrent size reduction of the CRT glass waste (prior to attaining the 2 inch nominal piece size) and mixing of the chemical treatment agent may reduce cycle time. In one implementation, the amount of the CRT glass waste and the chemical treatment agent are proportioned such that a majority of a volume of the voids throughout the final aggregate after evaporation or removal of the mixing liquid is filled or occupied by the chemical treatment agent from source 28. In one implementation, controller 34 generates control signals causing appropriate proportions of CRT glass waste and chemical treatment agent 28 such that a majority of the volume of the voids throughout the final aggregate after evaporation or removal of the mixing liquid is filled or occupied by the chemical treatment agent from source 28. As a result, the final aggregate has a desired density, grain size and permeability to achieve leaching characteristics satisfactory for use and recycling of the final aggregate as daily landfill cover.

In one implementation, controller 34 determines the amount and/or composition of chemical treatment agent to be supplied based upon a predetermined or preselected void fill percentage (permeability, density characteristic)\ or inertness/treatment standard and automatically generates control signals directing such chemical treatment agent to be supplied. In other implementations, controller 34 calculates or determines the recommended amount of chemical treatment agent to be added and may present the recommendation on display 42, awaiting confirmation by an operator and allowing operator to personally adjust or customize the recommended or default amount of chemical treatment agent. In other implementations, controller 34 determines the amount and/or composition of chemical treatment agent and directly controls the addition of the chemical treatment agent into mixer 26 using input 40.

In one implementation, controller 34 may receive other target proportions of the CRT glass waste and the chemical treatment agent via input 40 to achieve other degrees of treatment and/or void filling by the chemical treatment agent. The input degree of treatment and/or void filling desired may additionally impact the extent to which the chemical treatment agent and the CRT glass waste are mixed, impacting the operation of mixer 26 and the time for such mixing. Processing unit 48, following settings or calculations as instructed by instructions in memory 46, calculates such operational settings for achieving the selected treatment and/or void-filling characteristics or density characteristics of the final aggregate and generates control signals to adjust the operation of system 20 such that the final aggregate has the necessary density or permeability characteristics depending upon its desired recycled use. In other implementations, the proportions of CRT glass waste, chemical treatment agent and mixing liquid may be manually achieved by operator-controlled addition of such ingredients based upon visual inspection by the operator.

As noted above, in one implementation, the chemical treatment agent 28 supplied in step 104 comprises dolomitic lime and fly ash. In one implementation, the chemical treatment agent supplied by source 28 comprises a substantially equal blend of dolomitic lime and fly ash. In one implementation, the chemical treatment agent comprises an approximate 50:50 blend by weight or volume of dolomitic lime and fly ash. In one implementation, the fly ash itself is recycled, originating as a byproduct of coal combustion.

As indicated by step 106, controller 34 generates control signals directing source 30 to supply mixing liquid to the blend or mixture of untreated CRT glass waste and chemical treatment agent. In one implementation, the mixing liquid comprises water. In other implementations, the mixing liquid may comprise other liquids. The amount of mixing liquid supplied by controller 34 depends upon the amount of CRT glass waste, the amount of chemical treatment agent, the characteristics of the waste, the characteristics of the chemical treatment agent, and the desired characteristics of the final treated waste. Controller 34 determines the amount and/or composition of mixing liquid to be supplied based upon such information and automatically generates control signals directing such mixing liquid to be supplied. In other implementations, controller 34 calculates or determines the recommended amount of mixing liquid to be added and may present the recommendation on display 42, awaiting confirmation by an operator and allowing operator to personally adjust or customize the amount of mixing liquid. In other implementations, the amount of mixing liquid and/or its composition may be determined by the operator and may be manually applied by the operator. In one implementation, the mixing liquid is added after the addition of the chemical treatment agent. In another implementation, the mixing liquid is added prior to the addition of the chemical treatment agent to the CRT glass waste. In one implementation, the amount and/or composition of the mixing liquid is determined by controller 34 so as to initiate the chemical reaction and facilitate rapid and thorough mixing of the chemical treatment agent and the untreated CRT glass waste. With all the ingredients together, controller 34 generates control signals to initiate or continue mixing of the mix of chemical treatment agent and CRT glass waste with the mixing liquid to form a pre-cured blend. Controller 34 generates control signals continuing the mixing until a predetermined or preselected level of mixing has been achieved based upon mixing degree estimates calculated from historical mixing results or based upon real time sensed values of the pre-cured blend being mixed. In some implementations, such mixing continues until controller 34 receives a command or instruction via input 40 from an operator, wherein the operator has made the determination through experience or visual inspection.

As indicated by step 108, once the pre-cured blend has been sufficiently mixed or blended, controller 34 generates control signals causing the blend to be transferred to an available curing station 32. In implementations where curing takes place within the mixer 26, such a transfer is omitted. In one implementation, the transfer from the mixer 26 to curing station 32 is accomplished by portable heavy equipment. In one implementation, controller 34 tracks the time at which the pre-cured blend is allowed to cure to ensure sufficient curing. In one implementation, time is tracked by timer 44. In other implementations, curing time is manually calculated and documented. In one implementation, the pre-cured blend is cured for at least 10 hours and nominally for 12 to 30 hours.

As indicated by optional step 110, sampling and testing of the pre-cured blend prior to the initiation of curing, during curing or after curing may be carried out. In one implementation, TCLP analysis pursuant to USEPA methods and procedures is carried out on one or more samples of the mixed blend to demonstrate compliance with the USEPA treatment standards. If the USEPA treatment standards are met (or other applicable standards are met), the cured or treated aggregate of CRT glass waste and chemical treatment agent are removed from the curing station and shipped to a permitted landfill for land disposal. In some implementations, the final aggregate has sufficient or adequate characteristics enabling its recycled use as an alternative daily cover material for a landfill.

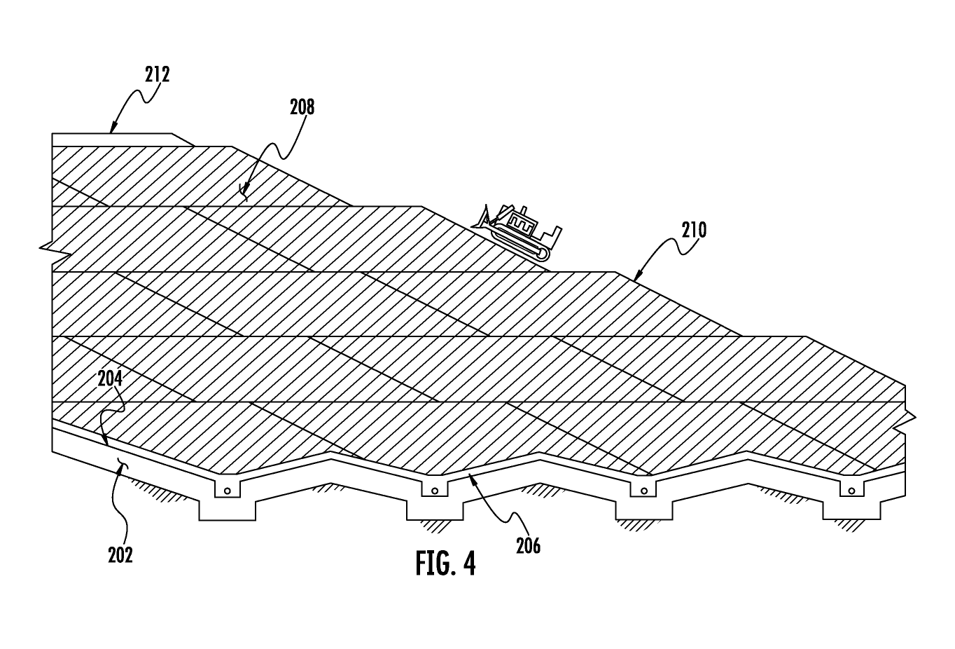

FIG. 4 illustrates an example landfill 200 employing the final aggregate produced by system 20 as a daily cover material. As shown by FIG. 4, landfill 200 comprises an impermeable clay barrier 202, a synthetic liner 204, a leachate collection and removal system 206, waste cells including daily and intermediate cover materials, and a final cover system. Combined, those engineered landfill components prevent environmental contamination.

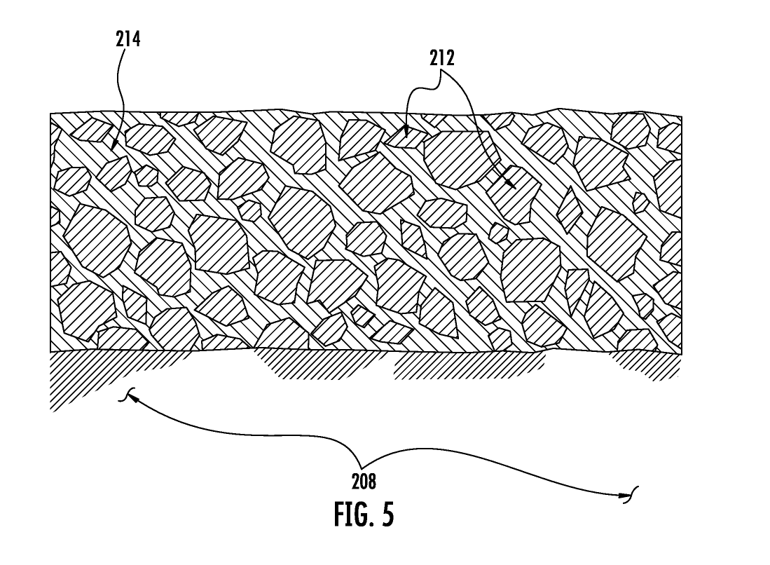

Daily cover 210 comprises a layer of permitted material applied each operating day over the top of waste that was placed during that operating day. Daily cover prevents wind-blown litter, sheds stormwater, prevents access by vectors, and minimizes the threat of fires. FIG. 5 is a sectional view of treated CRT glass waste used as daily cover layer 210. As shown by FIG. 5, daily cover layer 210 is formed from the final aggregate produced by method 100. Daily cover layer 210 comprises a layer that itself comprises an aggregate of treated CRT waste pieces 212 and chemical treatment agent 214. Each of the treated CRT waste pieces 212 has a piece size of less than or equal to 2 inches (nominal) in any one dimension. Chemical treatment agent 214 fills a majority of the volume of the voids, gaps, spaces or interstices throughout layer 210 such that the daily cover layer 210 meets all the USEPA requirements for daily cover. In the example illustrated, chemical treatment agent 214 fills at least 50% of the volume of the voids or gaps throughout layer 210. In other implementations, layer 210 may have other fill percentages for its voids and other corresponding densities or permeabilities. In one implementation, the chemical treatment agent 214 comprises a blend of dolomitic lime and fly ash. In one implementation, the blend comprises an essentially equal blend of dolomitic lime and fly ash. In one implementation, the fly ash itself is a recycled product of coal combustion.

Although the present disclosure has been described with reference to example embodiments, workers skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

What is claimed is:

1. A method comprising:
reducing cathode ray tube (CRT) glass waste to a piece size of less than or equal to 2 inches in any dimension;
mixing a chemical treatment agent comprising a blend of dolomitic lime and fly ash with the CRT glass waste;
mixing the mix of the chemical treatment agent and the CRT glass waste with a mixing liquid to form a pre-cured blend; and
curing the pre-cured blend to form a treated CRT glass waste.

2. The method of claim 1 further comprising applying the treated CRT glass waste as a daily cover material within a landfill.

3. The method of claim 1, wherein the chemical treatment agent comprise a substantially equal blend of dolomitic lime and fly ash.

4. The method of claim 1, wherein the fly ash is a product of coal combustion.

5. The method of claim 1, wherein the pre-cured blend is cured as necessary to accomplish the purpose of treatment.

6. The method of claim 1 further comprising sampling and testing the treated CRT glass waste to demonstrate compliance with the USEPA treatment standards.

7. The method of claim 1, wherein the treated CRT glass waste exhibits a leachable lead concentration no greater than 0.75 mg/l as determined using the TCLP test method.

8. The method of claim 1, wherein the CRT glass waste pieces and the chemical treatment agent, when mixed, form an aggregate, wherein the CRT glass waste pieces are separated by voids and wherein amounts of the CRT glass waste pieces in the chemical treatment agent are proportioned such that a majority of a volume of the voids throughout the aggregate is filled by the chemical treatment agent.

9. The method of claim 8, wherein amounts of the CRT glass waste pieces in the chemical treatment agent are proportioned such that the majority of the volume of the voids throughout the aggregate is filled by the chemical treatment agent.

10. The method of claim 1, wherein the chemical treatment agent is added to the CRT glass waste after the CRT glass waste is reduced in piece size to no greater than two inches in any dimension.

11. The method of claim 1, wherein the mixing liquid comprises water in an amount necessary to initiate the chemical reaction designed to accomplish the treatment purpose and facilitate rapid and thorough blending of the chemical treatment agent and the CRT glass waste.

12. An apparatus comprising:
a mixer;
a chemical treatment agent source;
an untreated cathode ray tube glass source;
a mixing liquid source; and
a controller to generate control signals: (1) causing the untreated cathode ray tube glass to be reduced to a piece size of less than or equal to 2 inches in any one dimension; (2) causing addition of the chemical treatment agent from the chemical treatment agent source to the untreated cathode ray tube glass; (3) causing the addition of a mixing liquid from the mixing liquid source to a mixture of the untreated cathode ray ii tube glass and the chemical treatment agent to form a thoroughly mixed pre-cured blend;
and (4) tracking a lapsed curing time period for the pre-cured blend whenever the curing time is not manually calculated.

13. The apparatus of claim 12, wherein the controller is configured to generate control signals such that amounts of the untreated cathode ray tube glass and the chemical treatment agent are proportioned such that the cured blend meets the applicable USEPA treatment standards.

14. The apparatus of claim 12, wherein the controller is configured to generate control signals such that amounts of the untreated cathode ray tube glass and the chemical treatment agent are proportioned such that a majority of a volume of the voids between pieces of the untreated cathode ray tube glass throughout the aggregate is filled with the chemical treatment agent.

15. The apparatus of claim 12, wherein the controller is configured to generate control signals such that amounts of the untreated cathode ray tube glass and the chemical treatment agent are proportioned such that at least 50% of a volume of the voids between pieces of the untreated cathode ray tube glass is filled with the chemical treatment agent.

16. The apparatus of claim 12, wherein the controller is further configured to cause untreated cathode ray tube glass to be supplied from the untreated cathode ray tube glass source to the mixer.

17. A daily cover material for a landfill, the daily cover comprising:
an aggregate of treated cathode ray tube glass pieces, each of the pieces separated from other pieces by voids and having a piece size of less than or equal to 2 inches in any one dimension; and
a chemical treatment agent filling a majority of a volume of the voids throughout the aggregate, wherein the aggregate exhibits a leachable lead concentration no greater than 0.75 mg/l as determined using the TCLP test method.

18. The landfill daily cover of claim 17, wherein amounts of the CRT glass waste pieces in the chemical treatment agent are proportioned such that a majority of the volume of the voids throughout the aggregate is filled by the chemical treatment agent.

19. The landfill daily cover of claim 18, wherein the chemical treatment agent comprises a blend of dolomitic lime and fly ash.

20. The landfill daily cover of claim 17, wherein the chemical treatment agent comprises a blend of dolomitic lime and fly ash.

21. The landfill daily cover of claim 20, wherein the blend comprises a substantially equal blend of dolomitic lime and fly ash.

22. The landfill daily cover of claim 20, wherein the fly ash is a product of coal combustion.
